(19) United States
(12) Patent Application Publication
(10) Pub. No.: US 2016/0308994 A1
(43) Pub. Date: Oct. 20, 2016

(54) Pre-Load of Video Content to Optimize Internet Usage

(71) Applicant: Carlos Manuel Gonzalez, Mission, TX (US)

(72) Inventor: Carlos Manuel Gonzalez, Mission, TX (US)

(21) Appl. No.: 14/690,458

(22) Filed: Apr. 19, 2015

(51) Int. Cl. H04L 29/08

(52) U.S. Cl. CPC H04L 67/2847; H04L 67/02; H04L 67/325

(57) ABSTRACT

A system to decrease the World Wide Web network usage at peak hours by clients requesting viewing of videos. The system will use a video content server and a software application running on a client's computer. The software application will schedule at off peak hours the pre-load of videos for the client. The selection of the pre-load list of videos will be calculated between the video content server and the software application based on the client's past behavior of video selections, and the current list of most popular videos available in the video content server. The pre-load videos will be stored at a client local storage. Whenever the client wants to watch videos a list of the pre-loaded videos will be presented and all selections done by the client on this list will save World Wide Web network peak hour utilization.

This application claims priority to U.S. Provisional Application No. 61/987,710 filed on May 2, 2014, entitled Pre-Load of Video Contents to Optimize Internet Usage, which is hereby incorporated by reference in its entirety.

### BACKGROUND OF THE INVENTION

With the advent of companies delivering video content through the World Wide Web (e.g. Netflix), the demand for network bandwidth has increased, mainly at certain hours in which most of the clients want to use the viewing of videos. The present invention will help decrease the demand for bandwidth at peak hours. I am proposing to pre-load at off peak hours (e.g. between 2 and 5 AM) the videos that a client wants to watch at peak hours. In order to do this, we will examine the current past behavior of the client in picking videos to watch, this list is generated by the company providing the video contents to the users. With this information and a list from the video content delivery company of most current target videos we will determine a pre-load list for each customer. The system will start the pre-load process at the determined pre-load time. The selected videos will be downloaded to a local disk area of the client's computer. Then whenever the client wants to watch a video, a list of the currently downloaded videos in the client's local disk is presented as a first choice for selection. If one or more of the pre-loaded videos is selected from the local storage, the downloaded of these videos at peak hours will be avoided. On the other hand if none are selected from the current local storage, then the user will use the normal channels to watch his/her selection. In both cases the client gets service, with a better response time when watching from the pre-loaded local disk, since there are no network delays.

### SUMMARY OF THE INVENTION

The goal of this invention is to decrease the World Wide Web network usage at peak hours by clients requesting viewing of videos.

The Pre-Load Video Content Management System is composed of four units: a user's computer who may support and run various different operating systems, such as Microsoft Windows, Mac OS, Google Chrome, Linux, Unix, Android, and so on; a Video Content Delivery Server called VCDS; a Client Video Delivery Software called CVDS running on the user's computer to manage the services of the Video Content Delivery Company that provides the user with video contents delivery; and the Client Intelligent Software Application called CLISA running on the user computer to manage the selection and download of the pre-load videos. The applications running on the user's computer communicate with the Video Content Delivery Server through the World Wide Web called WWW. All the communications between the VCDC and the CLISA will be done by secure communications over the WWW using protocols like HTTPS, which is Hypertext Transfer Protocol (HTTP) within a connection encrypted by Transport Layer Security or its predecessor, Secure Sockets Layer. The main motivation for HTTPS is authentication of the visited website and protection of the privacy and integrity of the exchanged data.

The VCDS is a computer server in the World Wide Web that belongs and is controlled by a company providing video content to users, and contains all the videos available for viewing by the CVDS, along with statistical information about client's video request.

The CLISA is an application software designed to run on a user personal computer (PC), or a Personal Digital Assistant (PDA), or any other information appliance devices that have access to the World Wide Web and has installed a CVDS. The CLISA will manage the pre-loading of videos into a client's local storage. The CLISA will start with a pre-load time; say 2 AM of the client's standard time, this time can later on be changed by the video delivery company or by the client. At the pre-load time, the CLISA will start gathering the information of the client's past behavior of video request, that are either stored and gathered by the CLISA, or are located in the VCDS. The CLISA also requests from CVDS a target list of the current most popular videos. When both information are present the CLISA proceeds to generate a pre-load list based on the past behavior of the client, and the type of videos in the target list.

Once the pre-load list is ready, CLISA precedes to request from the VCDS the download of the selected videos. Each video is downloaded in a predefined area of the client's disk storage. This storage will be required at installation time of the CLISA, and set aside for use by the CLISA exclusively. For protection, and depending on the video delivery company, the stored videos will be protected by password, and/or encrypted. This password and encrypted keys for each video will be stored in a file or database managed (also protected by password and/or encryption) only by the CLISA (this will help with the protection of the intellectual property rights of the data). Any intent of breaching these security barriers will be notified to the client's and a proper action will be done. The action(s) can go from a series of warnings up to a cancelation of the client's services.

The pre-load files in local storage will be erased whenever the user watches the video (unless is specifically told not to do so). In order to handle the case of having exhausted the allocated local storage, the CLISA will use a storage management algorithm like First In First Out (FIFO), or Lest Recently Used (LRU) rule to make enough space for the next pre-load video. Another option to clear space storage is from a direct command from the client. The client will be able to perform several local commands like the clear of storage, the setting of the pre-load time, setting and modifying the client's video preferences, and modifying the current pre-load list. The CLISA will also be able to handle system request (i.e. request done by the CVDS). These commands will help the CLISA update its current algorithms and process (i.e. get the next software version) of certain modules like the client current usage information processing module, the security check processing module, or the pre-load list processing module. Also some other system commands to change/set the pre-load time, change/set the maximum (i.e. number of videos or Gigabytes) in the pre-load list, or a command to clear the current local storage (i.e. clear all files older than n days, or clear all).

The CLISA will proceed after creating the pre-load list to request form the VCDS each of the pre-load videos, and store them in the local storage area. After done these actions, the CLISA will create the next pre-load event. And wait for such event.

### BRIEF DESCRIPTION OF THE DRAWINGS

Other objects and advantages of the invention will become more apparent from the specification taken in conjunction with the accompanying drawings, in which:

FIG. 1. is a high level system diagram of the invention

FIG. 2. is a high level system diagram of the Client Intelligent Software Application

FIG. 3. is a high level system diagram of the Target List Data Processing

FIG. 4. is a high level system diagram of the Pre-Load Cyclic Process Handling

FIG. 5. is a high level system diagram of the Pre-Load Processing

### DETAILED DESCRIPTION OF THE INVENTION

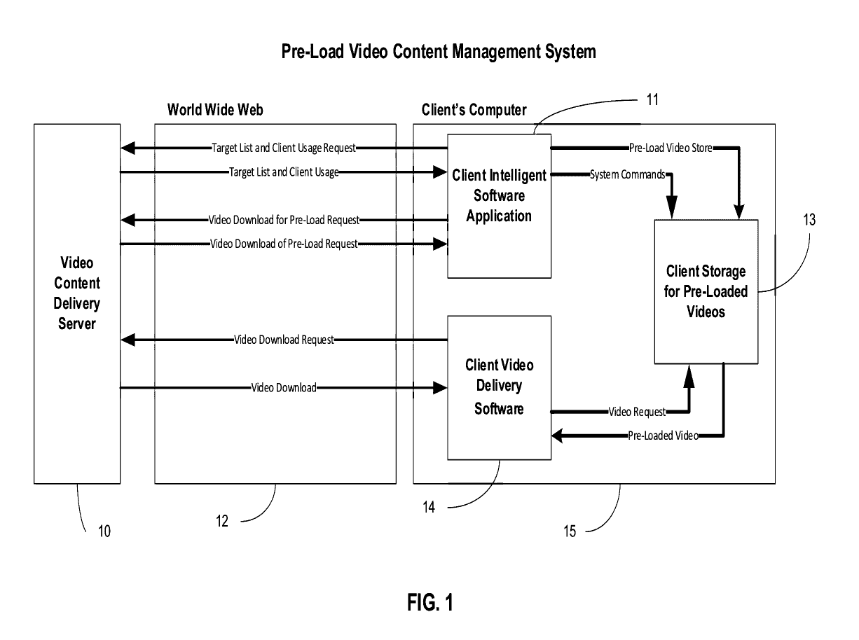

The Pre-Load Video Content Management System consist of three major components depicted in FIG. 1: a Video Content Delivery Server (VCDS) (number 10), the Client's Computer (number 15) communicating with each other through the World Wide Web (number 12).

The Video Content Delivery Server (number 10) is a computer server in the World Wide Web that belongs and is controlled by a company providing video content to users, and contains all the videos available for viewing by the client that has these services provided by the Video Content Delivery Company. located in the World Wide Web that contains all the videos available for viewing by the Client Intelligent Software Application (CLISA) number 11. The CLISA it is an application software designed to run on a client personal computer (PC), or a Personal Digital Assistant (PDA), or any other information appliance device that have access to the World Wide Web. The transfer of information between the VCDS server and the CLISA client is done through the World Wide Web (number 12).

The Client computer (number 15) is a computer that has at least the minimum system requirements (i.e. operating system type and version, memory, hard disk storage, etc.) required by the Video Content Delivery Company to provide its services. This Client computer usually contains many different software modules, among them depicted in FIG. 1, is the Client Video Delivery Software (number 14), and the Client Intelligent Software Application (CLISA) (number 11). Also included in this Client's computer is a Client Storage for Pre-Loaded Videos unit (number 13) that is a local storage unit in the Client's computer. This CLISA is the intelligent software making the decisions of which videos to pre-load and at what time. The Client Video Delivery Software (number 14) may not exist in the local client computer if the company providing the video content manages the client request via web pages in the Video Content Delivery Server (VCDS).

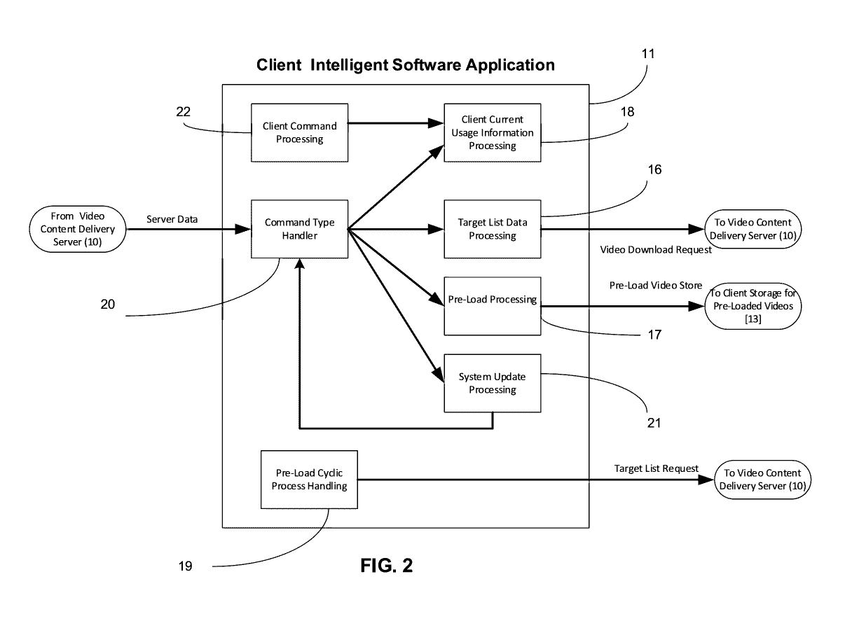

FIG. 2 depicts the CLISA processing (number 11). This process will be started by either of three ways:
1. A response from the VCDS (number 10) which will be handled by the Command Type Handler (number 20). The commands handled by this module are:
   a. A return of a Client Current Usage Information request handled by the Client Current Usage Information Processing module (number 18).
   b. A return of a Target List Data Request handled by the Target List Data Processing module (number 16).
   c. A return of a Pre-Load Request handled by Pre-Load Processing module (number 17)
   d. A system command heading handled by the System Update Processing module (number 21). Once the heading is processed the rest of the command is returned to the Command Type Handler (number 20) to be processed.
2. Internally called. Handled by the Pre-Load Cyclic Process Handler (number 19). This internal call can happen two ways: Whenever the user starts or re-starts his/her computer, or when the Pre-Load event is triggered.
3. A Client sends a local command, and it is handled by the Client Command Processing module (number 22). Some of the local commands are:
   a. Define the Pre-Load list given the current Target List.
   b. Define the client's video preferences.
   c. Modify the current Pre-Load list
   d. Delete a video from the local temporary video location.
   e. Modify the client's current video preferences.

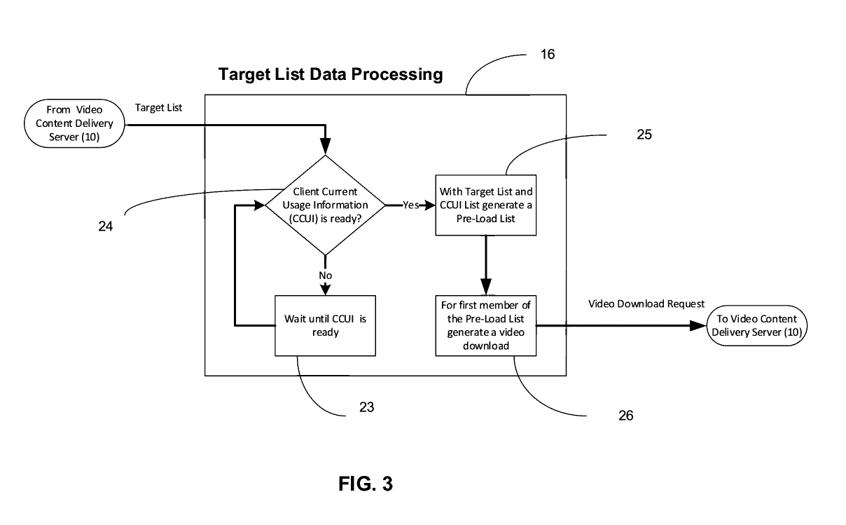

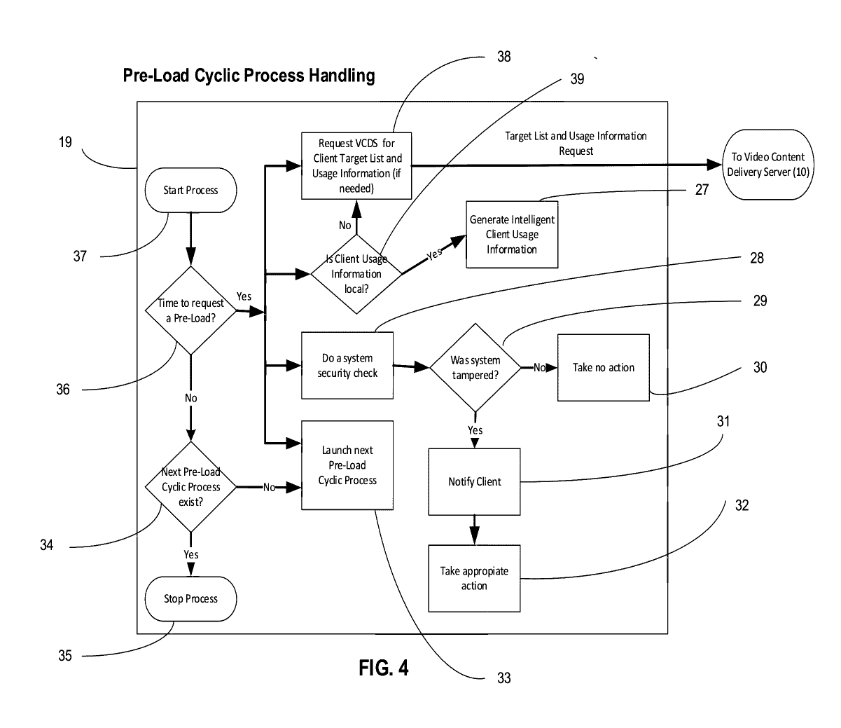

There are four types of information handled by the CLISA:
1. The Targeted List, which is a list of the current expected most sought videos request at the Video Content Delivery Server of the company providing these services. This information is handled by the Target List Data Processing module (number 16)
2. The data for the current pre-loading video. Handled by the Pre-Load Processing module (number 17)
3. The Client Current Usage Information. Handled by the Client Current Usage Information Processing module (number 18). The CCUI is comprised of the following information:
   a. Statistical information collected by the system about the client's usage of videos.
   b. Information about preferences of videos provided by the client.
   c. A client Pre-Load list with the client's preferences for video preloading given the latest available Target List.
4. System commands. Handled by the System Update Processing module (number 21). These commands are supposed to be piggy backed on the other 3 types of commands. Once the System Update Processing is done, the command that was piggy backed is then processed by the Command Type Handler. Some of the commands include:
   a. Change of Pre-Load time.
   b. Update for the CCUI processing module (FIG. 4 number 27)
   c. Set the maximum elements in the Pre-Load list.
   d. Update to the Security Check Processing module (FIG. 4 number 28)
   e. Update to the Pre-Load list generating module (FIG. 3 number 25)
   f. Clear the local pre-load storage.

FIG. 3 Depicts the Target List Data Processing module (number 16). This module is activated by the Target List data received from the VCDS (number 10). Before continue processing of this list, the system must have available the Client Current Usage Information (number 24). This CCUI can be in two places: at the local client's computer, or at the VCDS. Where the information is located will be a decision made by the company providing the VCDS services. If the CCUI is coming from the VCDS, and it is not available yet, the system must wait for it (number 23). Once the Target List and the CCUI are both available, the system proceeds to create a Pre-Load List which is a list in priority order of the expected client next request for videos in his/her next interaction with the Video Content Download Company owner of the VCDS (number 25). Once the Pre-Load List is created, the system will select the first video from the list and request the VCDS (number 10) for the download of such video (number 26). This request concludes the processing of the Target List Data Processing (number 16).

FIG. 4 Depicts the Pre-Load Cyclic Process Handling (number 19). As stated before, this process starts either when there is a system start/re-start or when the Pre-Load Cyclic event is triggered (number 37). The system checks first if it is time to do a Pre-Load (i.e. was the process started by the Pre-Load Cyclic event triggered?) (number 36). If this is not the case, it means the system was restarted. We need to check if a Pre-Load Cyclic Process exist (number 34). This is for the case the computer was off for more time than the previously created Pre-Load Cyclic Event. If this event already exists, just end this process (number 35). On the other hand, we need a Pre-Load Cyclic Event created for the future (number 33).

If it is time to do a Pre-Load, 4 simultaneous processes are spawned:
1. Request from the VCDS (number 10) for a Target List, and if the CCUI is not generated locally, include a request for the CCUI too (number 38).
2. If the CCUI is not generated locally (number 39), include a request for the CCUI too (number 38). Else the CCUI is generated from the local data available (number 27).
3. A system security check is done (number 28). This security check among other things will check that the client has not tried to open, move, copy, modify, etc. the files of the existent pre-loaded videos loaded in the client's computer. If the system was tempered (number 28), the user will be notified (number 31) of such transgression, and an appropriate action will be taken (number 32). This action or actions will be defined by the Video Content Download Company. On the other hand if no security breach was found, no action is needed (number 30) and this process may end.
4. The system generates the next Pre-Load Cyclic Process (number 33). This event is expected to be scheduled for the best times in the region of low usage in the World Wide Web. This time may be different for every client.

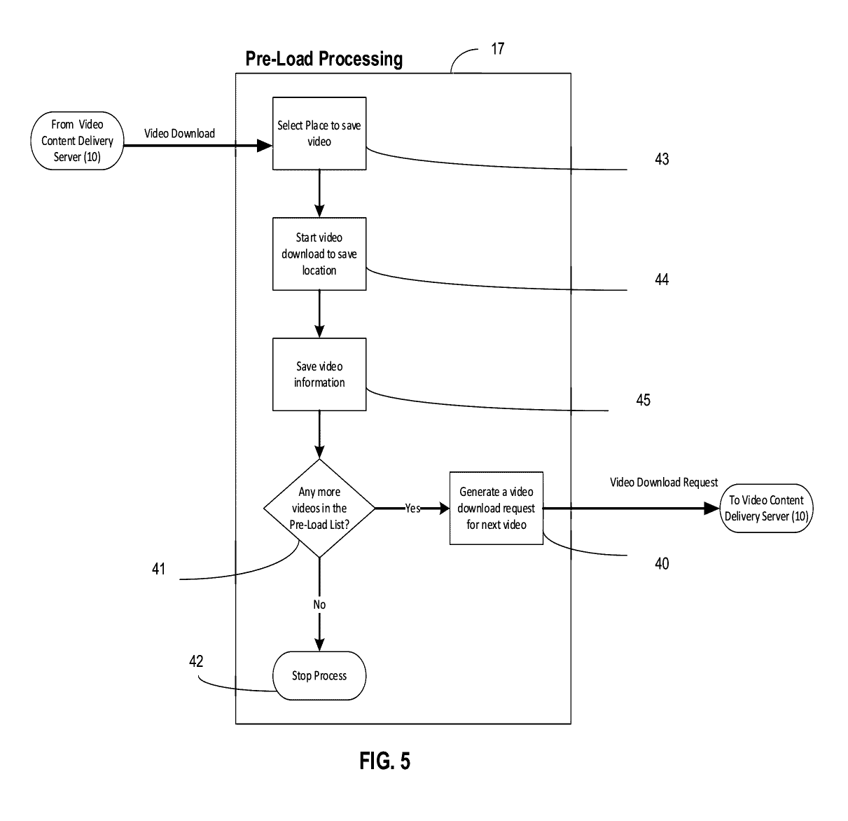

FIG. 5 Depicts the Pre-Load Processing module. This module is called whenever a pre-Loaded video is coming from the VCDS (number 10). The first thing the system does is search for file space to download the coming video. This file space is handled by a storage management algorithm like First In First Out (FIFO), or Lest Recently Used (LRU). A video file may be deleted from this space after the client watches the video, otherwise no videos are deleted unless space is needed and the storage management algorithm is used. Before installing the CLISA in the client's computer, an amount of file space will be required to have available.

The recommended space will have to be a minimum of 1 Giga byte. Less than this may cause the system to perform poorly (i.e. not doing any pre-loading). Once the location for the coming video is selected, the video is saved to such location (number 44). The Client Current Usage Information is updated with the information about the downloaded video (number 45). If there are any more videos to pre-load (number 41) the system generates a video download request for the next video in the pre-load list (number 40), otherwise the pre-load list is exhausted and the system stops this process (number 42).

The disclosure of the invention described herein-above represents the preferred embodiment of the invention; however, variations thereof, in the form, construction, and arrangement of the component thereof and the modified application of the invention are possible without departing from the spirit and scope of the appended claim.

I claim:

1. (canceled)

2. (canceled)

3. (canceled)

4. (canceled)

5. (canceled)

6. A computer system for managing the pre-load of video content based on clients estimated future video download requests to decrease World Wide Web traffic usage at clients peak hours comprised of: A computer of a client running a Client Video Delivery Software provided by a Video Content Delivery company to download video content from a Video Content Delivery Server located on the World Wide Web where said Video Content Delivery Server is owed by said Video Content Delivery company; a Client Intelligent Software Application running on the client's computer for clients to manage locally the pre-load of videos in their own computer devices; a Client Storage for Pre-Loaded Videos to locally store the pre-loaded videos; wherein said Video Content Delivery Server securely communicates with said Client Intelligent Software Application through the World Wide Web; wherein said Client Intelligent Software Application has a pre-load list generated by said Video Content Delivery company to determine a client's pre-load list of videos based on the Client Current Usage Information generated by said Video Content Delivery company which is the past client's requests for video downloads and a current Target List which is a list of the current videos available generated by said Video Content Delivery company; wherein said Client Intelligent Software Application determines which World Wide Web hours best decrease traffic usage for the client's pre-load downloading; wherein said Client Intelligent Software Application process at said selected best pre-load time the pre-load list with request for download videos form said Video Content Delivery Server; wherein said Client Intelligent Software Application manages the said Client Storage for Pre-Loaded Videos where the pre-load videos are stored temporarily until the client requires them.

7. The computer system and software modules of claim 6 wherein said Client Intelligent Software Application has a Security Check Processing module to monitor and manage the security of the data and space assigned for the pre-load videos.

8. The computer system and software modules of claim 6 wherein said Client Intelligent Software Application includes a Client Command Processing module to process local commands from the client; wherein said local commands include a command to define the Pre-Load list given the said Target List, a command to define the client's video preferences, a command to modify the current Pre-Load list, a command to delete a video from the local temporary video location, and a command to modify the client's current video preferences.

9. The computer system and software modules of claim 7 wherein said Client Intelligent Software Application includes a System Update Processing module to process system commands from the said Video Content Delivery Server; wherein system commands include a command to change the said selected best pre-load time, a command to update the software processing module for the said Client Current Usage Information, a command to set the maximum elements in the Pre-Load list, a command to update the software module of the said Security Check Processing module, a command to update the software module of the said Pre-Load list generating module, and a command to clear partially or all the local pre-load storage

10. The computer system and software modules of claim 8 wherein said Client Intelligent Software Application has a Security Check Processing module to monitor and manage the data and security of the space assigned for the pre-load videos; wherein said Client Intelligent Software Application includes a System Update Processing module to process system commands from the said Video Content Delivery Server; wherein system commands include a command to change the said selected best pre-load time, a command to update the software processing module for the said Client Current Usage Information, a command to set the maximum elements in the Pre-Load list, a command to update the software module of the said Security Check Processing module, a command to update the software module of the said Pre-Load list generating module, and a command to clear partially or all the local pre-load storage
